(19) United States
(12) Patent Application Publication
(10) Pub. No.: US 2017/0169613 A1
(43) Pub. Date: Jun. 15, 2017

(54) DISPLAYING AN OBJECT WITH MODIFIED RENDER PARAMETERS

(71) Applicant: LENOVO (Singapore) PTE. LTD., New Tech Park (SG)

(72) Inventors: Russell Speight VanBlon, Raleigh, NC (US); Justin Tyler Dubs, Raleigh, NC (US); Axel Ramirez Flores, Cary, NC (US); Robert James Kapinos, Durham, NC (US)

(21) Appl. No.: 14/970,201

(22) Filed: Dec. 15, 2015

(51) Int. Cl. G06T 19/00; G06T 11/00; G06T 3/60; G06F 3/16; G06T 3/40; G06T 15/10

(52) U.S. Cl. CPC G06T 19/006; G06T 3/40; G06T 15/10; G06T 3/60; G06F 3/165; G06T 11/001

(57) ABSTRACT

For displaying an object with modified render parameters, a processor calculates render parameters from object parameters for the object rendered by a virtual-reality device. The render parameters include a render geometry. The processor further modifies the render parameters according to a user policy. The processor displays the object based on the render parameters with the virtual-reality device.

### FIELD

The subject matter disclosed herein relates to displaying an object and more particularly relates to displaying an object with modified render parameters.

### BACKGROUND

### Description of the Related Art

Virtual-reality devices may be used to render an object in the context of an environment.

### BRIEF SUMMARY

An apparatus for displaying an object with modified render parameters is disclosed. The apparatus includes a virtual-reality device, a processor, and a memory. The memory stores code that is executable by the processor. The processor calculates render parameters from object parameters for an object rendered by the virtual-reality device. The render parameters include a render geometry. The processor further modifies the render parameters according to a user policy. The processor displays the object based on the render parameters with the virtual-reality device. A method and program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a perspective drawing illustrating one embodiment of virtual-reality devices rendering an object in an environment;

FIG. 1B is a schematic block diagram illustrating one embodiment of a virtual reality system;

FIG. 2A is a schematic block diagram illustrating one embodiment of object parameters;

FIG. 2B is a schematic block diagram illustrating one embodiment of render parameters;

FIG. 2C is a schematic block diagram illustrating one embodiment of a user policy;

FIG. 2D is a schematic block diagram illustrating one embodiment of a source policy;

FIG. 3A is a perspective drawing illustrating one embodiment of a first virtual-reality device rendering an object;

FIG. 3B is a perspective drawing illustrating one embodiment of a third virtual-reality device rendering an object;

FIG. 3C is a perspective drawing illustrating one embodiment of a first virtual-reality device rendering a screen;

FIG. 3D is a perspective drawing illustrating one embodiment of a second virtual-reality device rendering the screen;

FIG. 3E is a perspective drawing illustrating one embodiment of a third virtual-reality device rendering the screen;

FIG. 4 is a schematic block diagram illustrating one embodiment of a computer; and

FIG. 5 is a schematic flow chart diagram illustrating one embodiment of a modified render parameter display method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

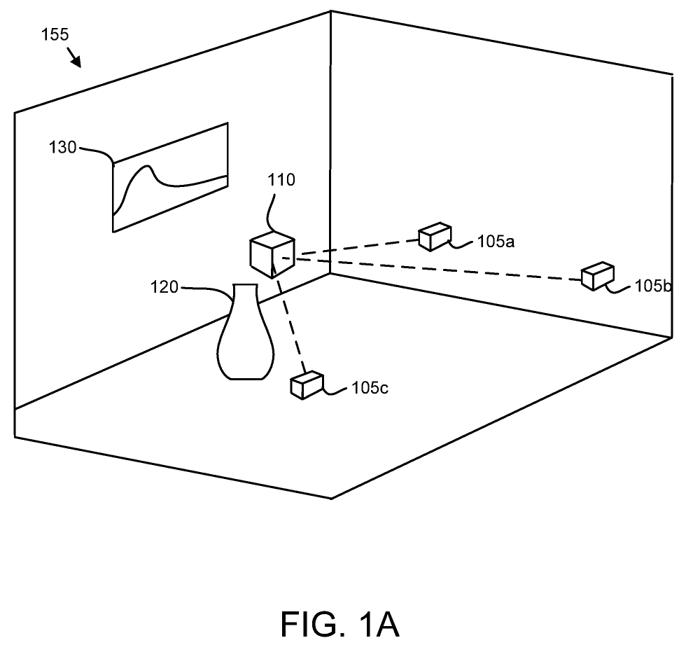

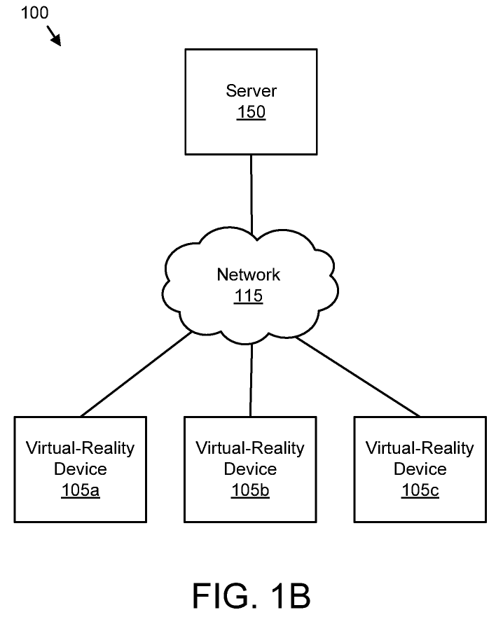

FIG. 1A is a perspective drawing illustrating one embodiment of virtual-reality devices rendering an object in a physical environment 155. In the depicted embodiment, three virtual-reality devices 105a-c are viewing an object 110. The object 110 is a virtual object and is only visible using the virtual-reality devices 105. However, the object 110 may also be influenced by physical objects 120 in the environment. For example, if the object 110 is rendered at a location relative to a physical location in the environment such as above a table, a virtual-reality device 105 that is further from the object 110 may render the object 110 is smaller then would another virtual-reality device 105 that is closer to the physical location of the object 110. In addition, some physical objects 120 may obscure or otherwise interfere with the rendered object 110.

The embodiments described herein calculate render parameters from the object parameters for the object 110 rendered by the virtual-reality device 105. The embodiments further modify the render parameters according to the user policy and display the object based on the render parameters with the virtual-reality device 105 as will be described hereafter. As a result, the rendering of the object 110 may be automatically enhanced for a virtual-reality device 105.

FIG. 1B is a schematic block diagram illustrating one embodiment of a virtual reality system 100. The system 100 may render the object 110 with the virtual-reality devices 105a-c. In the depicted embodiment, the system 100 includes a server 150, a network 115, and the virtual-reality devices 105a-c. Although for simplicity three virtual-reality devices 105a-c are shown, any number of virtual-reality devices 105 may be employed.

In one embodiment, the server 150 may store object parameters for the object 110. In addition, the server 150 may determine a location of each of the virtual-reality devices 105a-c and calculate render parameters from the object parameters. For example, the server 150 may calculate the render parameters as how the object parameters should appear from the location of each of virtual-reality device 105. In addition, the server 150 may modify the render parameters according to a user profile as will be described hereafter. The server 150 may communicate the modified render parameters over the network 115 to a virtual-reality device 105 and the virtual-reality device 105 may display the object 110 based on the render parameters.

Alternatively, the virtual-reality devices 105a-c may store the object parameters. In one embodiment, a virtual-reality device 105 may receive the object parameters from the server 150 through the network 115. The virtual-reality device 105 and/or the server 150 may determine a location of the virtual-reality device 105 and calculate the render parameters from the object parameters. The virtual-reality device 105 may modify the render parameters according to the user policy and display the object 110 based on the render parameters as will be described hereafter.

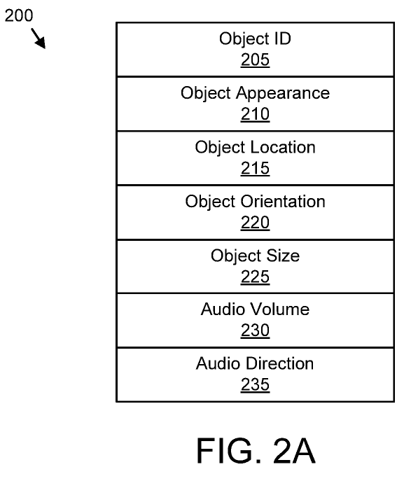

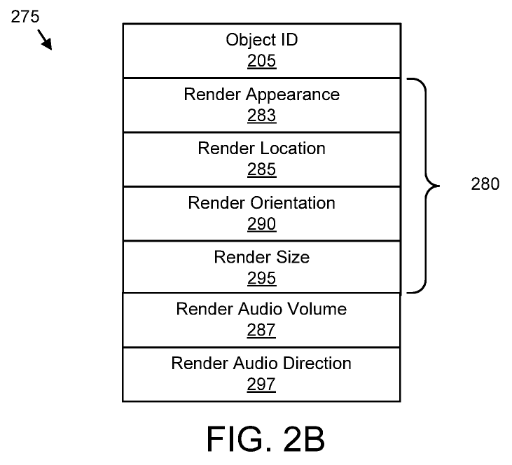

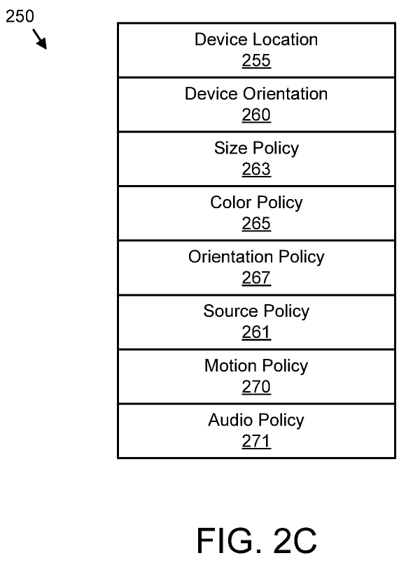

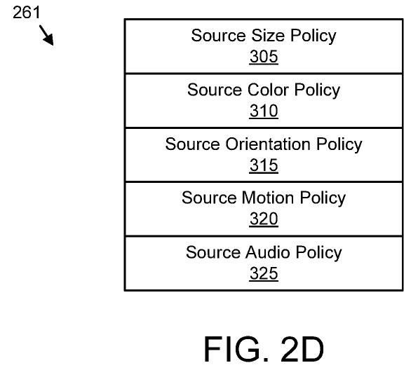

FIG. 2A is a schematic block diagram illustrating one embodiment of the object parameters 200. The object parameters 200 may describe the object 110. The object parameters 200 maybe organized as a data structure in a memory. In the depicted embodiment, the object parameters 200 include an object identifier 205, an object appearance 210, an object location 215, an object orientation 220, an object size 225, an audio volume 230, and an audio direction 235.

The object identifier 205 may uniquely identify the object 110. The object identifier 205 may be an index value. The object appearance 210 may describe an appearance of the object 110. In one embodiment, the object appearance 210 includes an aspect ratio and a video feed. The aspect ratio may describe the relative dimensions for displaying the video feed.

Alternatively, the object appearance 210 may describe one or more geometry primitives such as triangles and/or squares. In addition, the geometry primitives may include color values, reflectivity values, transparency values, luminescence values, and the like. In one embodiment, each geometry primitive may include a texture map.

The object location 215 may describe a physical location of the object 110 in the physical environment 155. The object location 215 may be an absolute location within the physical environment 155. Alternatively, the object location 215 may describe a location of the object 110 relative to another physical entity within the physical environment 155 such as a lecturer. In one embodiment, the object location 215 is described in absolute coordinates such as global positioning system (GPS) coordinates. Alternatively, the object location 215 may be described relative to a point and/or object in the physical environment 155. The object location 215 may also include motion information that specifies a motion of the object 110.

The object orientation 220 may describe an orientation of the object 110. In one embodiment, the object orientation 220 describes rotations of the object 110 about one or more axes such as an x axis, a y axis, and a z axis.

The object size 225 may specify an absolute scale size for the object 110. For example, the object size 225 may specify an absolute size of the object 110 so that gestures by a lecturer to the object 110 are directed to the same portions of the object 110 for all virtual-reality devices 105. Alternatively, the object size 225 may specify a relative scale size for the object 110 so that each virtual-reality device 105 sees the object 110 with the same angular size.

The audio volume 230 may specify a volume or intensity of an audio feed. The audio direction 235 may specify one or more audio source locations from which the audio feed will appear to be emanating, audio directions that the audio feed will appear to be emanating in, and audio shapes that will be simulated for the audio feed. The audio shapes may be a cone shape, a cardioid shape, or the like. For example, the audio direction 235 may specify that the audio feed appear to emanate from speakers offset by one meter to either side of the object 110, in an audio direction towards a virtual-reality device 105, and with a cardioid simulated audio shape.

FIG. 2B is a schematic block diagram illustrating one embodiment of the render parameters 275. The render parameters 275 may describe the object 110 as rendered by a virtual-reality device 105. The render parameters 275 maybe organized as a data structure in a memory. In the depicted embodiment, the render parameters 275 include the object identifier 205, the render appearance 283, the render location 285, the render orientation 290, the render size 295, the render audio volume 287, and the render audio direction 297.

The render appearance 283 may describe an appearance of the object 110 as displayed by the virtual-reality device 105. The render appearance 283 may be originally based on the aspect ratio and the video feed of the object appearance 210. Alternatively, the render appearance 283 may be originally calculated from the geometry primitives of the object appearance 210 so as to be rendered by the virtual-reality device 105.

The render location 285 may describe a virtual location of the object 110 relative to the physical environment 155. The render location 285 may be the virtual location of the object 110 is displayed by the virtual-reality device 105.

The render orientation 290 may describe an orientation of the rendered object 110 at the virtual location of the object 110 as displayed by the virtual-reality device 105. The render orientation 290 may describe rotations of the object 110 about one or more axes such as an x axis, a y axis, and a z axis.

The render size 295 may specify a scale size for the object 110 as rendered by the virtual-reality device 105. The render appearance 283, render location 285, render orientation 290, and render size 295 may be embodied in a render geometry 280.

The render audio volume 287 may specify the volume or intensity of the audio feed at the virtual-reality device 105. The render audio direction 297 may specify a perceived direction of the audio feed at the virtual-reality device 105 from simulated sources. The render parameters 275 may be further modified based on the user policy as will be described hereafter and displayed by the virtual-reality device 105 as will be described hereafter.

FIG. 2C is a schematic block diagram illustrating one embodiment of the user policy 250. The user policy 250 may specify one or more conditions that if satisfied results in the modification of the render parameters 275. In addition, the user policy 250 may specify the modifications to the render parameters 275. The user policy 250 may be organized as a data structure in a memory. In the depicted embodiment, the user policy 250 includes a device location 255, a device orientation 260, a size policy 263, a color policy 265, an orientation policy 267, a source policy 261, a motion policy 270, and an audio policy 271.

The device location 255 may describe the location of the virtual-reality device 105 in the physical environment 155. The location may be GPS coordinates, coordinates relative to a point in the physical environment 155, or combinations thereof The device orientation 260 may describe the orientation of the virtual-reality device 105. The orientations may describe rotations of the virtual-reality device 105 about one or more axes such as an x axis, a y axis, and a z axis.

The size policy 263 may modify the render geometry 280. The size policy 263 may specify modifications to one or more of an angular size, a relative size, and an absolute size of the object 110 as rendered by the virtual-reality device 105. For example, the size policy 263 may specify that the object 110 have an absolute size in proportion to the physical environment 155. As a result, the size policy 263 may modify the render appearance 283 so that the object 110 appears to have the same size proportional to the physical environment 155 for all virtual-reality devices 105.

Alternatively, the size policy 263 may specify a relative size for the object 110 such that the object 110 has a size proportional to another object. For example, the size policy 263 may specify that the object 110 have the same relative size to each virtual-reality device 105. In addition, the size policy 263 may specify an angular size for the object 110 as rendered by the virtual-reality device 105. For example, the size policy 263 may specify that the object 110 have an angular size of 15 degrees as displayed by each virtual-reality device 105.

In one embodiment, the size policy 263 may modify the render geometry 280 as a function of an available display space. For example, the size policy 263 may increase the size of the object 110 to a maximum size relative to the physical environment 155. In one embodiment, the maximum size relative to the physical environment 155 is such that the object 110 does not appear to contact any physical objects 120 in the physical environment 155. Alternatively, the maximum size relative to the physical environment 155 is such that no physical object 120 bleeds into the object 110.

In one embodiment, the size policy 263 modifies the render geometry 280 as a function of user visual abilities. The server 150 and/or virtual-reality device 105 may access a user profile for the user of the virtual-reality device 105 and determine the user's visual abilities. Alternatively, the virtual-reality device 105 may perform a test of the user's visual abilities. In one embodiment, the size policy 263 increases the size of the object 110 by modifying the render geometry 280 to compensate for user visual abilities that are less than a visual ability standard.

The size policy 263 may modify the render geometry 280 as a function of text characteristics of the object 110. For example, the object 110 may comprise one or more alphanumeric characters. The size policy 263 may modify the render geometry 280 so that the alphanumeric characters have text characteristics consistent with the size policy 263. For example, the render geometry 280 may be modified so that all alphanumeric characters appear to be at least a 12 point character. In addition, the render geometry 280 may be modified so that the alphanumeric characters are displayed in a preferred font.

The color policy 265 may modify the render geometry 280 based on color. For example, the color policy 265 may specify preferred color pixel combinations to form a color. For example, a white color for the color policy 265 of the first user may include more blue than a white color for the color policy 265 of a second user.

Alternatively, the color policy 265 may modify the render geometry 280 to compensate for color blindness. For example, the virtual-reality device 105 and/or server 150 may access a user profile for the user of the virtual-reality device 105 to determine if the user is color blind. Alternatively, the virtual-reality device 105 may test the user for color blindness. The color policy 265 may substitute colors that the user can distinguish for colors that the user cannot distinguish in the render geometry 280. In one embodiment, the user may select the color substitutions.

The orientation policy 267 may modify the render geometry 280 including the render orientation 290 as a function of the virtual-reality device location 255 and/or virtual-reality device orientation 260. For example, the orientation policy 267 may modify the render geometry 280 so that one of a front of the object 110, a top of the object 110, a side of the object 110, a bottom of the object 110, and/or a back of the object 110 is oriented towards the virtual-reality device 105. The render geometry 280 may specify the portion that is oriented towards the virtual-reality device 105.

The source policy 261 may modify the render geometry 280 as a function of a source of the object 110. The source may be the creator of the object 110 such as a lecturer. Alternatively, the source may identify a video feed, a database, an object type, or the like. The source policy 261 is described in more detail in FIG. 2D.

In one embodiment, the motion policy 270 modifies the render geometry 280 as a function of object motion. For example, if motion of the object 110 takes the object 110 outside of the physical environment 155 and/or results in the object 110 appearing to contact a physical object 120, the motion policy 270 may modify the render geometry 280 so that the object 110 stays within the physical environment 155, does not appear to contact the physical object 120, and/or remains within a predefined motion volume.

The audio policy 271 may modify the render audio volume 287 and/or render audio directionality 297 as a function of the virtual-reality device location 255 and/or the virtual-reality device orientation 260. In one embodiment, the audio policy 271 modifies the render audio volume 287 to a specified intensity regardless of the distance of the virtual-reality device 105 from the object 110. In addition, the audio policy 271 may modify the positions of virtual audio sources or speakers to maximize a stereo effect.

FIG. 2D is a schematic block diagram illustrating one embodiment of the source policy 261. The source policy 261 may be organized as a data structure in a memory. In the depicted embodiment, the source policy 261 includes a source size policy 305, the source color policy 310, a source orientation policy 315, a source motion policy 320, and a source audio policy 325.

The source size policy 305 may modify the render geometry 280 as a function of the object source. In one embodiment, the source size policy 305 specifies whether to render the object 110 with an absolute size proportional to the physical environment 155, with a relative size proportional a specified object, and/or an angular size relative to the display of the object 110 on the virtual-reality device 105.

The source color policy 310 may modify the render geometry 280 as a function of the object source. In one embodiment, the source color policy 310 specifies color pixel combinations for one or more colors if the object 110 is from a specified source.

The source orientation policy 315 may modify the render geometry 280 as a function of the object source. For example, a source may specify that the object 110 be displayed by the virtual-reality devices 105 in a specified view such as the front view. Alternatively, the source orientation policy 315 may specify that the object 110 maintain a constant orientation relative to the physical environment 155. As a result, a source/lecturer may gesture to portions of the object 110 with each virtual-reality device 105 seeing the portions at the same location.

The source motion policy 320 may modify the render geometry 280 as a function of the object source. In one embodiment, the source motion policy 320 may specify the predefined motion volume. As a result, a source/lecturer may gesture to the object 110 moving within the predefined motion volume such that all the virtual-reality devices 105 see the object 110 at the same location relative to the lecturer's gesture.

The source audio policy 325 may modify the render audio volume 287 and/or the render audio direction 297 as a function of the object source. In one embodiment, the source audio policy 325 specifies virtual speaker locations relative to each virtual-reality device 105.

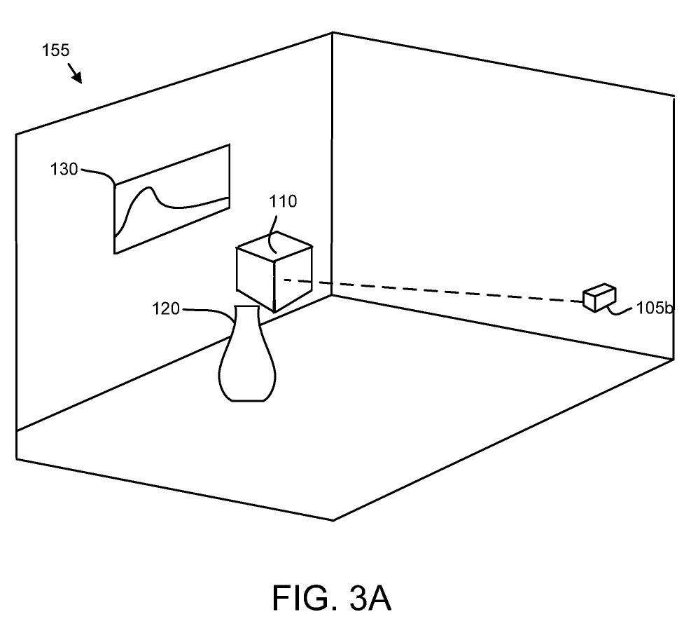

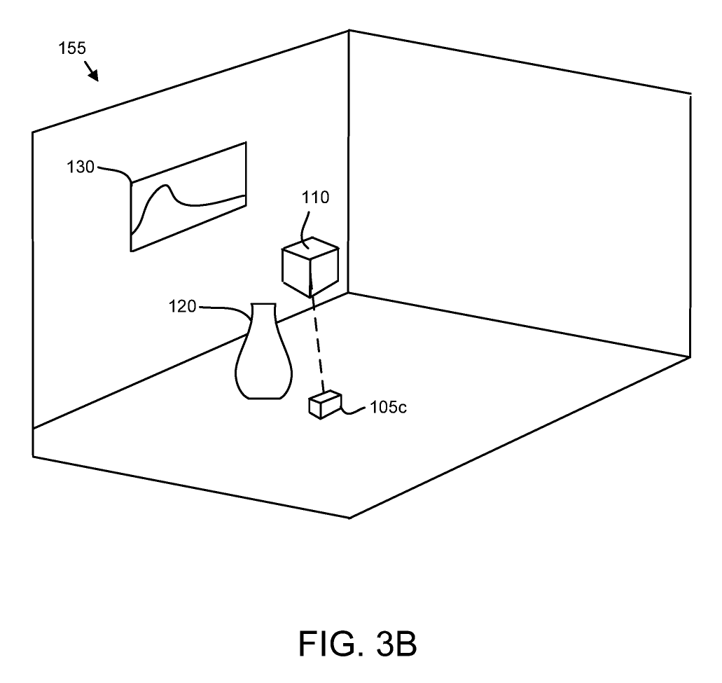

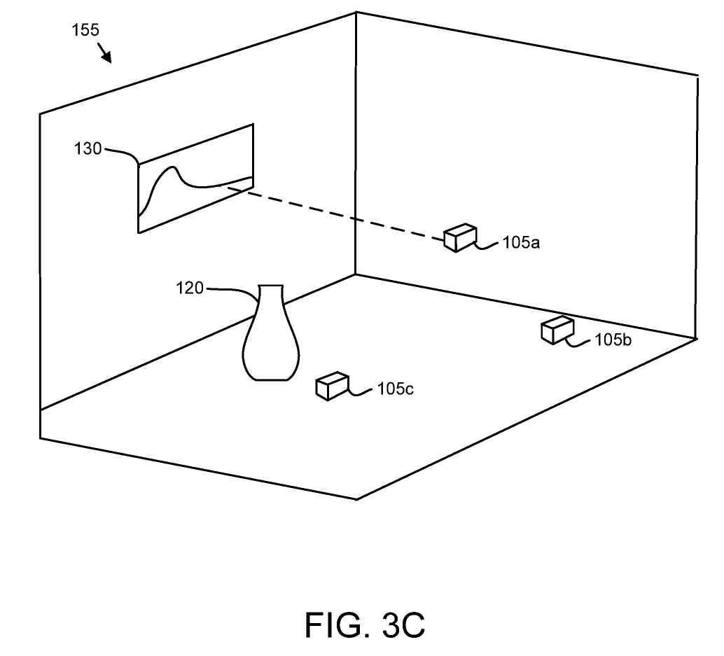

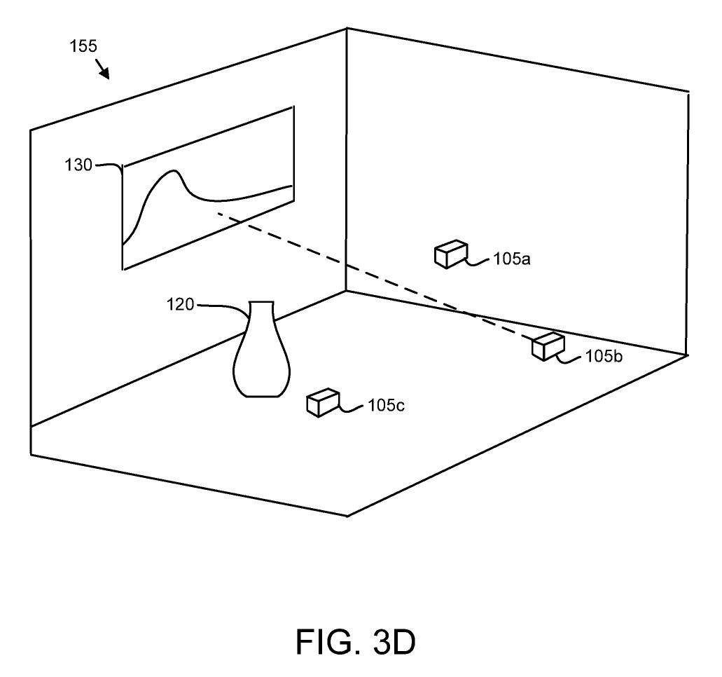

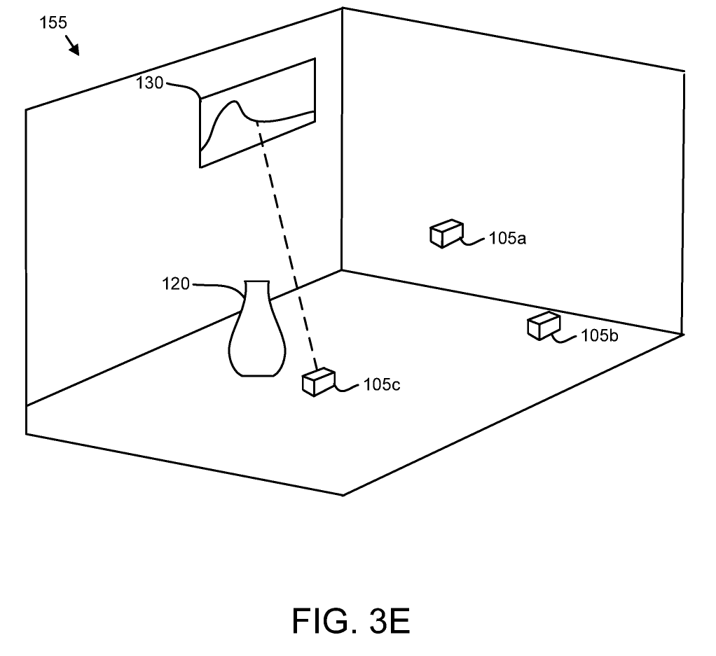

FIG. 3A is a perspective drawing illustrating one embodiment of a first virtual-reality device 105a rendering the object 110. In the depicted embodiment, the object 110 is rendered by the first virtual-reality device 105a with a first location and size. FIG. 3B shows the same object 110 rendered by the second virtual-reality device 105b at a second different location and with smaller size. In one embodiment, the object 110 is rendered at the second location so that the object 110 does not bleed into the physical object 120.

FIG. 3C is a perspective drawing illustrating one embodiment of a first virtual-reality device 105a rendering a screen 130. The screen 130 may be a virtual screen and may be positioned on a wall or in the air. The screen 130 is rendered by the first virtual-reality device 105a with the first location and size. FIG. 3D shows the screen 130 rendered at the same first location but with the second larger size by the second virtual-reality device 105b. The screen 130 may be rendered with the second larger size because the second virtual-reality device 105b is farther from the location of the screen 130 than is the first virtual-reality device 105a. FIG. 3E shows the screen 130 rendered at a second location with the first size by the third virtual-reality device 105c. The screen 130 may be shown at the second location so that the screen 130 does not appear to bleed into the physical object 120.

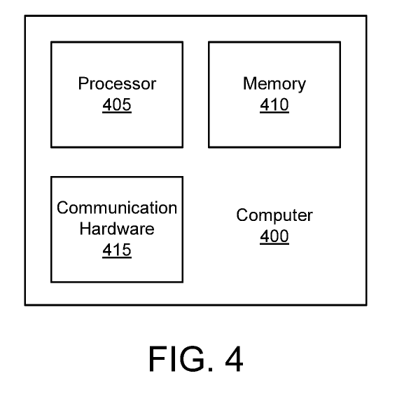

FIG. 4 is a schematic block diagram illustrating one embodiment of a computer 400. The computer 400 may be embodied in the server 150 and/or the virtual-reality devices 105. In the depicted embodiment, the computer 400 includes a processor 405, a memory 410, and communication hardware 415. The memory 410 may comprise a semiconductor storage device, a hard disk drive, an optical storage device, a micromechanical storage device, or combinations thereof. The memory 410 may store code. The processor 405 may execute the code. The communication hardware 415 may communicate with other devices. For example, the communication hardware 415 of the virtual-reality device 105 and the communication hardware 415 of the server 150 may communicate with the network 115.

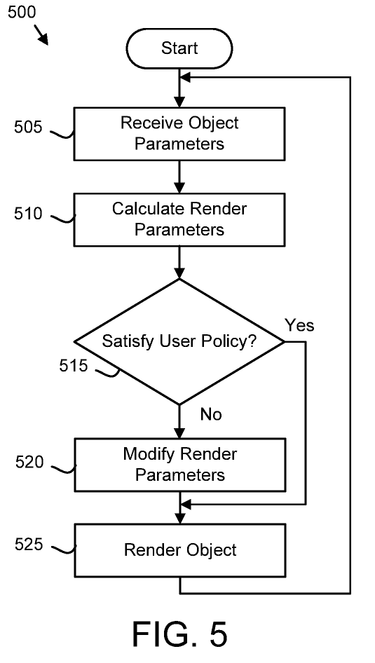

FIG. 5 is a schematic flow chart diagram illustrating one embodiment of a modified render parameter display method 500. The method 500 may display the object 110 based on the modified render parameters 275 with the virtual-reality device 105. The method 500 may be performed by the processor 405.

The method 500 starts, and in one embodiment, the processor 405 receives 505 the object parameters 200 for the object 110. The object parameters 200 may be received 505 from the database, a video feed, a simulation, or the like.

The processor 405 may further calculate 510 the render parameters 275 from the object parameters 200. In one embodiment, the render parameters 275 transform the object parameters 200 in order to display the object 110 with a specified location, orientation, and size within the physical environment 155.

The processor 405 may determine 505 if the render parameters 275 satisfy the user policy 250. If the render parameters 275 satisfy the user policy 250, the processor 405 may render 525 the object 110 based on the render parameters 275.

If the render parameters 275 do not satisfy the user policy 250, the processor 405 may modify the render parameters 275 according to the user policy 250. For example, the size policy 263 may specify an angular size for the object 110. The processor 405 may modify the render parameters 275 to scale the object 110 to the specified angular size. Alternatively, the color policy 265 may specify that green be rendered with a blue tint and that red be rendered with a yellow tint for a color blind user. As a result, the color policy 265 may modify the render appearance 283 by modifying green and red colors accordingly.

In one embodiment, the orientation policy 267 may specify that the front of the object 110 is oriented towards the virtual-reality device 105. The orientation policy 267 may modify the render orientation 290 so that the front of the object 110 is oriented towards the virtual-reality device 105.

The source policy 261 may specify modifications to the render geometry 280 and/or render audio volume 287 and render audio direction 297 based on the source of the object 110. For example, the source size policy 305 of the source policy 261 may specify that the object 110 be rendered with an absolute size relative to the physical environment 155. The source policy 261 may modify the render size 295 so that each the virtual-reality device 105 displays the object 110 with a size proportional to the physical environment 155.

By modifying the render parameters 275 according to the user policy 250, the embodiments may enhance the viewing experience at each virtual-reality device 105. As a result, the user of each virtual-reality device 105 may be able to clearly view the object 110 with an advantageous size and orientation. In addition, the displayed colors and received simulated audio for the object 110 may also be enhanced for the user, further improving the user experience.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a virtual-reality device;
a processor;
a memory that stores code executable by the processor to:
calculate render parameters from object parameters for an object rendered by the virtual-reality device, wherein the render parameters comprise a render location, a render orientation, and a render size of the object rendered in a physical environment;
determine whether the render parameters satisfy a user policy of conditions that if satisfied specifies modifications to the render parameters, wherein the user policy specifies a condition that the object appears to bleed into a physical object at the render location in the physical environment by occulting the physical object;
in response to the object appearing to bleed into the physical object, modify the render location so that the object at the modified render location does not appear to bleed into the physical object according to the user policy; and
display the object based on the render parameters with the virtual-reality device.

2. The apparatus of claim 1, wherein the user policy further comprises a size policy that the object does not appear to contact the physical object, and wherein in response to the object appearing to contact the physical object, the processor modifies the render size so that the object with the modified render size does not appear to contact the physical object.

3. The apparatus of claim 1, wherein the user policy further comprises a size policy that the object have a specified angular size on the virtual-reality device, and where in response to the object not having the specified size, the processor modifies the render size so that the object has the specified angular size on the virtual-reality device.

4. The apparatus of claim 3, wherein the size policy specifies the angular size as a function of user visual abilities.

5. The apparatus of claim 3, wherein the size policy specifies the angular size as a function of text characteristics so that all alphanumeric characters appear to be at least a specified font size.

6. The apparatus of claim 1, wherein the user policy comprises a source policy that modifies the render geometry as a function of an object source.

7. The apparatus of claim 1, wherein the user policy comprises a motion policy that modifies the render geometry as a function of object motion.

8. The apparatus of claim 1, wherein the user policy comprises a color policy that modifies the render geometry based on color.

9. The apparatus of claim 1, wherein the user policy comprises an orientation policy that modifies a render orientation as a function of a virtual-reality device location.

10. The apparatus of claim 1, wherein the user policy comprises an audio policy, the render parameters comprises one or more of a render volume and a render audio directionality, and the audio policy modifies the render volume and/or render audio directionality as a function of a virtual-reality device location.

11. A method comprising:
calculating, by use of a processor, render parameters from object parameters for an object rendered by a virtual-reality device, wherein the render parameters comprise a render location, a render orientation, and a render size of the object rendered in a physical environment;
determining whether the render parameters satisfy a user policy of conditions that if satisfied specifies modifications to the render parameters, wherein the user policy specifies a condition that the object appears to bleed into a physical object at the render location in the physical environment by occulting the physical object;
in response to the object appearing to bleed into the physical object, modifying the render location so that the object at the modified render location does not appear to bleed into the physical object according to the user policy; and
displaying the object based on the render parameters with the virtual-reality device.

12. The method of claim 11, wherein the user policy further comprises a size policy that the object does not appear to contact the physical object, and wherein in response to the object appearing to contact the physical object, the processor modifies the render size so that the object with the modified render size does not appear to contact the physical object.

13. The method of claim 11, wherein the user policy further comprises a size policy that the object have a specified angular size on the virtual-reality device, and where in response to the object not having the specified size, the processor modifies the render size so that the object has the specified angular size on the virtual-reality device.

14. The method of claim 13, wherein the size policy specifies the angular size as a function of user visual abilities.

15. The method of claim 13, wherein the size policy specifies the angular size as a function of text characteristics so that all alphanumeric characters appear to be at least a specified font size.

16. A program product comprising a computer readable storage medium that stores code executable by a processor, the executable code comprising code to perform:
calculating render parameters from object parameters for an object rendered by a virtual-reality device, wherein the render parameters comprise a render location, a render orientation, and a render size of the object rendered in a physical environment;
determining whether the render parameters satisfy a user policy of conditions that if satisfied specifies modifications to the render parameters, wherein the user policy specifies a condition that the object appears to bleed into a physical object at the render location in the physical environment by occulting the physical object;
in response to the object appearing to bleed into the physical object, modifying the render location so that the object at the modified render location does not appear to bleed into the physical object according to the user policy; and
displaying the object based on the render parameters with the virtual-reality device.

17. The program product of claim 16, wherein the user policy further comprises a size policy that the object does not appear to contact the physical object, and wherein in response to the object appearing to contact the physical object, the processor modifies the render size so that the object with the modified render size does not appear to contact the physical object.

18. The program product of claim 17, wherein the user policy further comprises a size policy that the object have a specified angular size on the virtual-reality device, and where in response to the object not having the specified size, the processor modifies the render size so that the object has the specified angular size on the virtual-reality device.

19. The program product of claim 17, wherein the size policy specifies the angular size as a function of user visual abilities.

20. The program product of claim 17, wherein the size policy specifies the angular size as a function of text characteristics so that all alphanumeric characters appear to be at least a specified font size.
